(19) United States
(12) Patent Application Publication
(10) Pub. No.: US 2023/0351903 A1
(43) Pub. Date: Nov. 2, 2023

(54) PATH ESTIMATOR FOR DRONE

(71) Applicant: AIRBUS HELICOPTERS, Marignane Cedex (FR)

(72) Inventors: Arnaud MESNIL, Cabries (FR); Julien SIMON, Peypin D'Aigues (FR)

(73) Assignee: AIRBUS HELICOPTERS, Marignane Cedex (FR)

(21) Appl. No.: 18/135,370

(22) Filed: Apr. 17, 2023

(30) Foreign Application Priority Data
Apr. 28, 2022 (FR) 2203939

(51) Int. Cl. G08G 5/00; G01C 23/00

(52) U.S. Cl. CPC G08G 5/0069; G01C 23/00

(57) ABSTRACT

A method for helping to keep a drone within an authorized airspace. This method involves displaying several symbols on a display of a path estimator comprising: i) displaying an aircraft symbol showing a current position of the drone in relation to the authorized airspace; ii) displaying a boundary symbol showing a boundary of the authorized airspace in a position in relation to the aircraft symbol representative of a position of the boundary in relation to the current position of the drone; and iii) determining a geometry and displaying a path symbol showing a predicted path of the drone without changing values of an item of speed data and an item of navigation data, the geometry of the path symbol being based at least on the value of the item of speed data and the value of the item of navigation data.

### CROSS REFERENCE TO RELATED APPLICATIONS

This application claims priority to French patent application No. FR 22 03939 filed on Apr. 28, 2022, the disclosure of which is incorporated in its entirety by reference herein.

### TECHNICAL FIELD

The present disclosure relates to a path estimator for a drone.

### BACKGROUND

A drone is an unmanned aircraft. A drone may, for example, be controlled remotely by a pilot using controls in wireless communication with the drone.

The airspace in which a drone is authorized to operate may be limited. It may be difficult for a pilot not on board the drone to keep the drone within a limited space remotely.

Document FR 2 841 977 B1 is far removed from this problem, since it relates to a method for assisting the navigation of an aircraft and, more particularly, for helping align the aircraft with a predetermined path. This method comprises determining, according to the wind, the geometry of a feeler line, i.e., the ground path that the aircraft would follow if a turn at the maximum rate applicable to the current flight phase of the aircraft were to begin at that instant. The method also comprises displaying, on a navigation display of the aircraft, the feeler line and a ground path to be captured with which the aircraft needs to be aligned, in order to turn the aircraft in such a way as to optimize the capture of the ground path to be captured. The aircraft can then be turned when the feeler line is tangential to the ground path to be captured.

Similarly, documents FR 2 920 232 B1 and US 2009/055037 A1 relate to a method and a device for assisting the piloting of an aircraft in order to capture a flight axis, such as an in-flight refuelling axis or an approach axis, while complying with a roll instruction. The device comprises means for determining, based on the roll instruction and measured current values of external characteristics and flight characteristics of the aircraft, a predicted path that is a flight path having a constant roll angle, taking account of the effect of the wind. A pilot may vary the value of the roll instruction until a possible path is obtained that is tangential to the flight axis to be joined.

Document US 2021/375143 A1 describes an unmanned aerial vehicle that may comprise a flight controller configured to generate one or more signals that cause the unmanned aerial vehicle to function according to a set of flight rules generated from a geolocation device.

Document US 2012/150426 A1 describes a system and a method for monitoring an aircraft and anticipating a possible deviation from an air corridor. In particular, this method discloses the following steps: receiving aircraft state data, predicting a future position of the aircraft based on the aircraft state data; and generating an alert in response to the comparison between the predicted future position and an air traffic navigation constraint assigned to the aircraft.

### SUMMARY

An object of the present disclosure is thus to propose a path estimator for a drone that aims to simplify the work of an off-board pilot in order to comply with the boundaries of an authorized airspace.

The present disclosure relates to a method for helping to keep a drone within an authorized airspace. This method comprises the following steps:
determining, with a path estimator not embedded on the drone, a value of an item of speed data of said drone and a value of an item of location data carrying a current position of the drone and a value of an item of navigation data of the drone making it possible to assess whether the drone is flying in a straight line or performing a turn; and
displaying several symbols on a display of said path estimator, said displaying of several symbols comprising: i) displaying an aircraft symbol showing a current position of the drone, in relation to said authorized airspace; ii) displaying a boundary symbol showing a boundary of said authorized airspace in a position in relation to the aircraft symbol representative of a position of the boundary of said authorized airspace in relation to the current position of the drone; and iii) determining a geometry and displaying a path symbol showing a predicted path of the drone without changing values of the item of speed data and the item of navigation data, said geometry of the path symbol being a shape of the path symbol determined using a stored model based at least on the value of the item of speed data and the value of the item of navigation data.

The model may, for example, comprise one or more mathematical laws, one or more equations, etc.

The path estimator is configured to then determine the values of the speed, navigation and location data. To this end, the path estimator may comprise a receiver receiving at least one of these items of speed, navigation and location data, for example originating from the drone in a conventional manner, or for receiving an item of information enabling it to calculate at least one of the values of the speed, navigation and location data.

Therefore, the expression “determining, with a path estimator not embedded on the drone, a value of an item of speed data of said drone and a value of an item of location data carrying a current position of the drone and a value of an item of navigation data of the drone” means that the path estimator receives at least one signal and decodes it in order to deduce therefrom the value of at least one of said items of data and/or that the path estimator calculates the value in question.

The item of location data makes it possible to estimate the current position of the drone in relation to a boundary of the authorized airspace. The item of navigation data can be used to assess whether the drone is flying in a straight line or performing a turn in order to ascertain whether the drone is heading towards such a boundary of the authorized airspace. Finally, the item of speed data can be used to assess whether the drone is approaching such a boundary of the authorized airspace in the short term.

Therefore, the path estimator is configured to deduce and position, on a display, at the very least, an aircraft symbol, a boundary symbol, at least when the boundary symbol can appear on the display, and a path symbol.

A pilot of the drone can then see on the display where the drone is located in relation to the boundaries of the authorized airspace and can know if the drone is likely to exit the authorized airspace in the short term if the path of the drone is not changed. If the path symbol intersects the boundary symbol, the drone will cross a boundary of the authorized airspace in the short term. The pilot may then take the appropriate measures in order to modify the path of the drone and keep it within the authorized airspace.

The method is therefore not a method for establishing an intercept path like those disclosed in documents FR 2 841 977 B1 and FR 2 920 232 B1. The path estimator is not intended to assess joining paths that depend on possible roll instructions. The method instead makes it possible to predict the successive positions of the drone in the short term in order for an off-board pilot to be able to keep the drone in an authorized airspace.

The method may comprise one or more of the following features.

According to one possibility, said path symbol may be positioned in relation to a current heading angle or a current track angle of said drone.

The track angle is sometimes referred to as the “track”. The track angle and the heading angle are the same when there is no wind or sideslip.

The path symbol may therefore be tangential to a straight line directed at the current heading angle or track angle. Each of these angles may be measured by the drone or another system and transmitted to the path estimator, or may be calculated by the path estimator or another piece of equipment based on successive positions of the drone, for example.

According to one possibility compatible with the preceding possibilities, said item of speed data may be an air speed or a ground speed, and/or said item of navigation data may be a roll angle or a track angle or a heading angle.

The item of speed data can be used to assess whether the drone is quickly approaching a boundary of the authorized airspace. The ground speed may be determined in a conventional manner and may be used. Alternatively, an air speed is conventionally measured by a drone and may be used.

Moreover, the item of navigation data is an item of data making it possible to assess whether the drone is travelling in a straight line or performing a turn. For example, the item of navigation data may comprise a navigation angle, i.e., a roll angle of the drone or a track or heading angle that may be used to estimate the path of the drone in relation to the ground.

According to one possibility compatible with the preceding possibilities, before the step of displaying several symbols, said method may comprise determining whether the drone is flying in a straight line or performing a turn based on the item of navigation data with or without hysteresis, said path symbol being in the form of a segment during a flight in a straight line and a curve during a turn.

For example, the path estimator may consider that the drone is following a straight line or a turn based on a value of the current roll angle by comparison to a single navigation threshold, or with hysteresis by using at least two navigation thresholds in order to prevent chattering.

According to another example, the derivative or the pseudo-derivative over time of the track or heading angle may be used.

Depending on the situation, the calculated shape of the path symbol is modified by the path estimator, appearing either as a continuous or discontinuous straight line segment during straight-and-level flight or as a continuous or discontinuous curve or arc when performing a turn.

According to one possibility compatible with the preceding possibilities, before the step of displaying several symbols and when a turn is being performed, the method may comprise using the path estimator to determine a turn radius based on the item of speed data and the item of navigation data, said geometry of the path symbol being based on the turn radius, and possibly also on a fixed or adjustable time period and/or the wind.

According to one example, the path symbol is in the shape of an arc with the turn radius multiplied by a scale factor.

In this case, the wind is not taken into consideration when calculating the shape of the curve of the path symbol. Taking the wind into consideration makes the path followed and the shape of the path symbol more complex. Since the purpose of the path estimator is to provide indications to an off-board pilot, such an approximation may be sufficient.

According to another example, the path symbol may take not only the turn radius but also the wind into consideration. The path symbol is then not necessarily in the shape of an arc, depending on the speed and direction of the wind.

Depending on the nature of the item of navigation data, the turn radius may be estimated in various ways.

According to a first variant for calculating the turn radius, the turn radius may be determined using the following relation:

R=(V*V)/(g*tan(phi))

where “R” represents the turn radius, in meters, for example, “V” represents the item of speed data, in meters per second, for example, “g” represents the acceleration of gravity, in meters per second squared, for example, “phi” represents the item of navigation data in the form of a roll angle, in radians, for example, “=” represents the equals sign, “/” represents the division sign and “*” represents the multiplication sign.

According to a second variant for calculating the turn radius, the turn radius may be determined using the following relation:

R=V/(dxi/dt)

where “R” represents the turn radius, “V” represents the item of speed data, “dxi/dt” represents the derivative or the pseudo-derivative over time of the item of navigation data in the form of a track or heading angle, “=” represents the equals sign and “/” represents the division sign.

According to one possibility compatible with the preceding possibilities, said aircraft symbol may be positioned along a first geometric axis dividing a screen of the display into a first side and a second side, during a said turn, the method comprises determining the position of a center along a second axis orthogonal to the first axis at a distance from the aircraft symbol equal to the product of the turn radius and the scale factor, said method comprising comparing the value of the item of navigation data with at least one navigation threshold, said center being positioned on the first side or the second side depending on said comparison, said path symbol having an arc starting from said aircraft symbol and centered on said center.

The first axis may be fixed and/or aligned with the current heading or track angle. The first axis may be aligned with a segment of the aircraft symbol.

For example, when the item of navigation data is a positive roll angle, the path symbol is situated to the right of the first axis, and when the item of navigation data is a negative roll angle, the path symbol is situated to the left of the first axis.

According to the example, when the item of navigation data is a track or heading angle and the derivative of this track or heading angle is positive, the path symbol is situated to the right of the first axis, and when the item of navigation data is a track or heading angle and the derivative of this track or heading angle is negative, the path symbol is situated to the left of the first axis.

According to one possibility compatible with the preceding possibilities, said path symbol may carry said predicted path that the drone will follow for a fixed or adjustable upcoming time period, a length of the path symbol being limited in order not to exceed a predetermined length.

Said time period may be set using a human-machine interface of the path estimator or may be fixed and stored. For example, the time period is equal to 30 seconds.

In order to obtain readable information, the length of the path symbol may be limited. According to one example, when a turn is being performed, the path symbol may at most cover a semi-circle.

According to one possibility compatible with the preceding possibilities, said displaying of the path symbol may be disabled below a stored air speed or ground speed of the drone, with or without hysteresis.

At low speed, for example less than 30 knots, i.e., approximately 15.4 meters per second, the path symbol may not be displayed. Indeed, at this speed, the pilot may quickly correct the path of the drone. Furthermore, the speed measurements may be approximate and may result in a path symbol being displayed that bears little relation to reality.

The presence of a low speed or a high speed may be determined without hysteresis or with hysteresis in order to prevent chattering close to a speed threshold.

According to one possibility compatible with the preceding possibilities, said method may comprise filtering at least one item of data from said item of speed data and said item of navigation data with a low-pass filter.

Such a filter may help eliminate erroneous data, for example following a temporary problem in receiving or transmitting information.

According to one possibility compatible with the preceding possibilities, said displaying of several symbols may comprise displaying, on the display, a representation of the overflown terrain on top of which the aircraft symbol, the boundary symbol and the path symbol are superposed.

For example, such a representation may be in the form of a map, which may or may not include the boundary symbol.

In addition to a method, the disclosure also relates to a non-embedded path estimator for a drone configured to implement said method.

The disclosure also relates to a kit comprising a drone and such a path estimator not embedded on the drone.

The drone may comprise a speed sensor measuring said item of speed data and a navigation sensor measuring said item of navigation data and a position sensor measuring said item of location data, said drone having a transmitter transmitting said item of speed data and said item of navigation data and said item of location data, said path estimator having a receiver receiving said item of speed data and said item of navigation data and said item of location data.

The path estimator may be configured to display the boundary symbol, the aircraft symbol and the path symbol.

The path estimator may be configured to store a geographical location of a boundary delimiting an authorized airspace and/or a geographical map of the overflown terrain possibly containing this boundary.

The path estimator may be configured to position said path symbol in relation to a heading angle or a current track angle.

The path estimator may be configured to determine whether the drone is flying in a straight line or performing a turn based on the item of navigation data, with or without hysteresis, said path symbol comprising a segment during a flight in a straight line and a curve when performing a turn.

The path estimator may be configured to determine a turn radius based on the item of speed data and the item of navigation data.

The path estimator may be configured to not display said path symbol below a predetermined air or ground speed, with or without hysteresis.

The path estimator may be configured to filter at least one item of data from said item of speed data and said item of navigation data with a low-pass filter.

### BRIEF DESCRIPTION OF THE DRAWINGS

The disclosure and its advantages appear in greater detail in the context of the following description of embodiments given by way of illustration and with reference to the accompanying figures, in which:

FIG. 1 shows a kit having a drone and a path estimator according to the disclosure;

FIG. 2 shows a logic diagram depicting the method of the disclosure;

FIG. 3 shows a view of a display displaying a straight path symbol;

FIG. 4 shows a view of a display displaying a curved path symbol;

FIG. 5 shows a view of a display limiting a length of a curved path symbol; and

FIG. 6 shows a view of a display displaying an aircraft symbol that is able to move in relation to the display.

### DETAILED DESCRIPTION

Elements that are present in more than one of the figures are given the same references in each of them.

FIG. 1 shows a path estimator 20 according to the disclosure. The path estimator 20 may belong to a set comprising a drone 1, the path estimator 20 not being embedded on the drone 1.

This path estimator 20 may possibly be an integral part of a control station controlling a drone 1, this control station comprising conventional controls.

This path estimator 20 is provided with a display 21. The display 21 may comprise a screen 210, such as, for example, a screen of a tablet computer, a helmet visor, a glasses lens, or the like.

The path estimator 20 comprises a controller 22 capable of controlling the display 21 in order to display various symbols. The controller 22 may comprise at least one computer.

The term “computer” may denote a processing unit comprising, for example, at least one processor at least one integrated circuit, at least one programmable system, at least one logic circuit, these examples not limiting the scope given to the expression “computer”. The term “processor” may refer equally to a central processing unit (CPU), a graphics processing unit (GPU), a digital signal processor (DSP), a microcontroller, etc.

For example, the controller 22 may comprise a processing computer 221 carrying out various processing operations and a symbol generator computer 222 generating the symbols to be displayed. The controller 22 may be fully or partially integrated into the display 21, for example in a tablet computer.

The path estimator 20 may comprise a memory 23 in wired or wireless communication with the controller 22. This memory 23 may store at least one geographical map of a terrain 102 overflown by a drone 1, and/or a predetermined time period value and/or the geographical coordinates of at least one boundary 101 of an authorized airspace 100 and/or a code applied by the controller 22. A geographical map of a terrain 102 may incorporate such a boundary 101.

The path estimator 20 may comprise a human-machine interface 25 in wired or wireless communication with the controller 22 in order to allow an operator to set various parameters, for example setting said time period.

The path estimator 20 may comprise a receiver 24 capable of receiving data by wired or wireless means.

For example, the receiver 24 may be in communication with at least one sensor 10 via at least one transmitter 14.

In particular, the receiver 24 may be in communication with a speed sensor 11 transmitting, via a transmitter 14, a signal carrying an item of speed data DVIT of the drone 1, such as an air speed or a ground speed, for example. Such a speed sensor 11 may, for example, comprise an inertial unit embedded on the drone 1, an AHRS embedded on the drone 1, or a Pitot tube speed sensor embedded on the drone 1. A speed sensor 11 may comprise a receiver of a satellite positioning system embedded on the drone 1 or a sensor of a radar station, the controller 22 or a computer of the speed sensor being able to determine a speed of the drone 1 based on successive current positions PCUR of the drone 1 in a conventional manner. These examples are only given to illustrate the disclosure.

For the record, the acronym “AHRS” stands for “Attitude and Heading Reference System”.

The receiver 24 may be in communication with a location sensor 12 transmitting, via a transmitter 14, a signal carrying an item of position data DPOS of the drone 1, either directly in the form of coordinates, for example, or indirectly via speeds allowing said coordinates to be determined from a departure position in a conventional manner. Such a location sensor 12 may, for example, comprise an inertial unit embedded on the drone 1, an AHRS embedded on the drone 1, a Pitot tube speed sensor embedded on the drone 1, a receiver of a satellite positioning system embedded on the drone 1 or a sensor of a radar station.

The receiver 24 may be in communication with a navigation sensor 13 transmitting, via a transmitter 14, a signal carrying an item of navigation data DNAV of the drone 1, such as a heading angle ACAP or a track angle ATRACK or indeed a roll angle AROL, either directly or via successive current positions of the drone 1. Such a navigation sensor 13 may, for example, comprise an inertial unit embedded on the drone 1, an AHRS embedded on the drone 1, a Pitot tube speed sensor embedded on the drone 1, a receiver of a satellite positioning system embedded on the drone 1 or a sensor of a radar station.

According to one example, the drone 1 comprises at least one of the speed 11, position 12 and navigation 13 sensors connected to a transmitter 14. For example, to this end, the drone 1 comprises a system known by the acronym ADS-B, standing for the expression “Automatic dependent surveillance-broadcast”.

According to one example, a radar station may comprise at least one of the speed 11, position 12 and navigation 13 sensors connected to a transmitter 14.

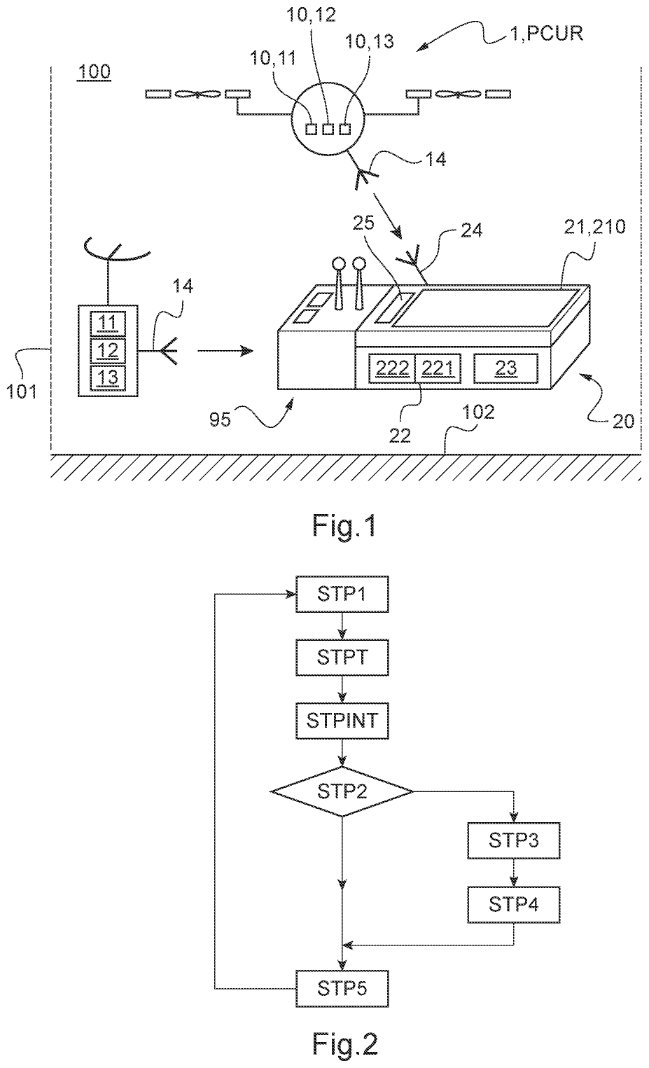

Irrespective of the embodiment of the path estimator 20, this path estimator 20 is configured to apply the method of the disclosure shown in the form of a logic diagram in FIG. 2.

The path estimator 20 is configured to carry out the steps described hereinafter in a loop.

Therefore, the path estimator 20 is configured to determine STP1 the value of the item of speed data DVIT of the drone 1 that is being observed, the value of the item of location data DPOS carrying the current position PCUR of the drone 1 and the value of the item of navigation data DNAV of the drone 1.

According to one example, the controller 22 and, for example, a processing computer 221, receives and decodes the signals received by the receiver 24, either in order to directly retrieve one or more of said values, or in order to calculate it or them. For example, the controller 22 calculates the ground speed VS and/or the heading ACAP or track ATRACK angle of the drone 1 in a conventional manner, based on successive positions of said drone 1. These examples are given by way of illustration, and a person skilled in the art is able to design a path estimator 20 capable of determining said values using many different techniques.

Irrespective of how this determination step STP1 is implemented, following this determination step STP1, the path estimator 20 may use the value of an item of speed data DVIT of the drone 1, the ground speed VS or an air speed and, in particular, the true air speed TAS, for example, the value of an item of position data, the coordinates of the drone 1 in the terrestrial reference frame, for example, and the value of at least one item of navigation data, a heading angle ACAP or a track angle ATRACK or indeed a roll angle AROL, for example.

The path estimator 20 is furthermore configured to display STP5 several symbols on the display 21, possibly under condition.

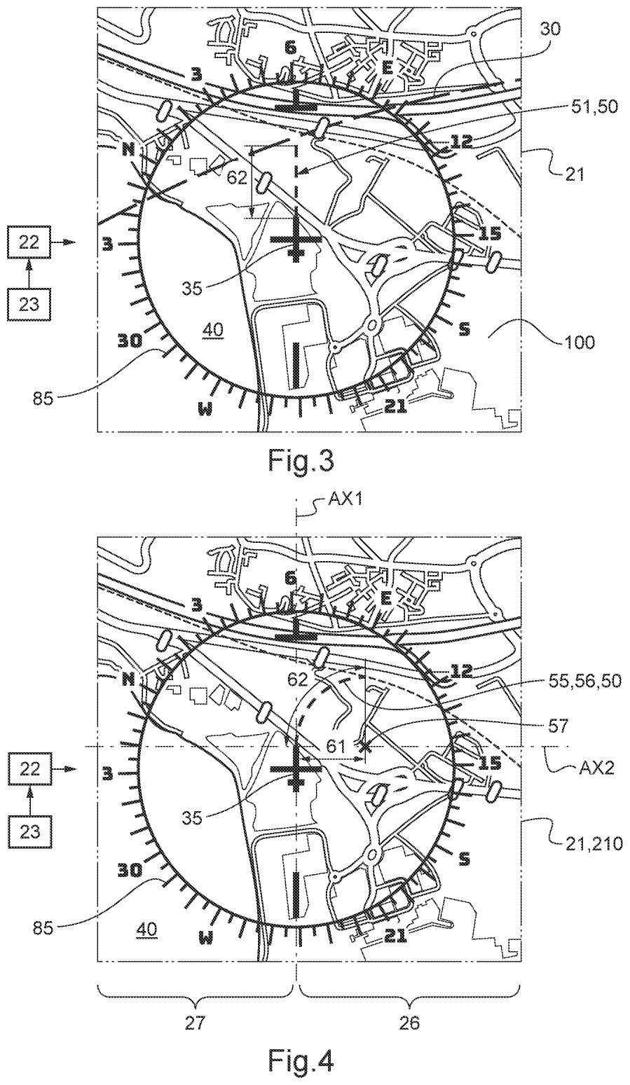

In reference to FIG. 3, the controller 22 is configured to control the display 21 in order to display an aircraft symbol 35 positioned on the display 21 in a location showing the current position PCUR of the drone 1 in the authorized airspace 100. For example, the aircraft symbol 35 has a fixed shape, possibly substantially in the form of a two-barred cross. For example, this aircraft symbol 35 is always positioned in a particular location on the display 21, possibly always in the same predetermined position. For example, on a display 21 that is square or rectangular in shape, the nose of the aircraft symbol 35 is positioned where the diagonals of this shape intersect.

The controller 22 possibly controls the display 21 in order to display, in a conform manner, a representation 40 of the terrain 102 overflown by the drone 1. The aircraft symbol 35 may then be arranged superposed on this representation 40. The controller 22 is in particular configured so that the representation 40 represents a portion of the terrain situated in line with the current position PCUR of the drone 1 and to display the aircraft symbol 35 in a conform manner in line with this current position PCUR on the representation 40. This representation 40 may be stored in the memory 23.

The controller 22 is configured to control the display 21 in order to display a boundary symbol 30, superposed on said representation 40, if appropriate. The boundary symbol 30 is in the form of a curve showing the boundary 101 of the authorized airspace 100.

The geographical coordinates of this boundary may be stored in the memory 23. Therefore, the controller 22 may be configured to determine the shape of the boundary symbol 30 in order for the boundary symbol 30 to extend, in relation to the aircraft symbol 35, in the same location as the boundary 101 in relation to the drone 1, subject to the scale factor of the path estimator.

Alternatively, the boundary symbol 30 may be an integral part of the representation 40. In other words, the displayed representation 40 is a part of a geographical map on which said boundary 101 is drawn.

The controller 22 is configured to control the display 21 in order to determine the shape of a path symbol 50 and display that path symbol 50. The path symbol 50 shows a predicted path of the drone 1 without changing values of the item of speed data DVIT and the item of navigation data DNAV, and possibly without wind. The controller 22 is configured to calculate the geometry of the path symbol 50 based on at least, or only, the value of the item of speed data DVIT and the value of the item of navigation data DNAV.

The path symbol 50 is optionally positioned in such a way as to be tangential or indeed at least locally superposed on a straight line passing through the drone 1 and directed at a current heading angle ACAP or a current track angle ATRACK of said drone 1.

According to one possibility shown in particular in FIG. 3, the controller 22 may display, on the display 21, a heading or track scale 85 that is able to move in relation to the aircraft symbol 35. According to the example in FIG. 6, the heading or track scale 85 is fixed, the aircraft symbol 35 being able to move in relation to this scale.

In reference to FIG. 2, the method may comprise a step of disabling STPT the displaying of the path symbol 50 below a stored air speed TAS or ground speed VS of the drone 1, with or without hysteresis.

According to an example without hysteresis, the controller 22 compares the value of the item of speed data DVIT with a single speed threshold. If the value of the item of speed data DVIT is greater than or equal to the threshold, displaying the path symbol 50 is authorized. If the value of the item of speed data DVIT is less than the threshold, displaying the path symbol 50 is prohibited.

Alternatively, the controller 22 may make this comparison with hysteresis by making the comparison with two speed thresholds. Starting from a situation in which displaying the path symbol 50 is authorized, if the value of the item of speed data DVIT is decreasing and drops below a first speed threshold, for example 30 knots, i.e., approximately 15.4 meters per second, displaying the path symbol 50 becomes prohibited. Starting from a situation in which displaying the path symbol 50 is disabled, if the value of the item of speed data DVIT is increasing and passes above a second speed threshold, the second speed threshold being greater than the first speed threshold and, for example, 35 knots, i.e., approximately 18 meters per second, displaying the path symbol 50 becomes active.

Before the step of displaying STP5 several symbols, the path estimator 20, or indeed the controller 22, may filter STPINI the value of the item of speed data DVIT and/or the value of the item of navigation data DNAV with a low-pass filter, for example of the order of one or more seconds.

Moreover, in order to determine the geometry of the path symbol 50, before the step of displaying STP5 several symbols, the path estimator 20, or indeed the controller 22, may be configured to determine STP2 whether the drone 1 is flying in a straight line or performing a turn based on the item of navigation data DNAV, with or without hysteresis. Indeed, the path estimator 20, or the controller 22, or the symbol generator 222, may be configured to depict the path symbol 50 in the form of a segment 51 during straight line flight and a curve 55 during a turn.

According to one example, the path estimator 20, or the controller 22, compares the value of the item of navigation data DNAV with a single navigation threshold.

For example, if the value of the item of navigation data DNAV is a positive or negative roll angle, the path estimator 20 or the controller 22 considers the drone 1 to be performing a turn. If the value of the item of navigation data DNAV is equal to zero, the path estimator 20 or the controller 22 considers the drone 1 to be flying in a straight line.

Alternatively, the path estimator 20, or the controller 22, may make this comparison with hysteresis by making the comparison with at least two navigation thresholds.

Starting from a situation in which the drone 1 is performing a turn, if the absolute value of the item of navigation data DNAV is a positive roll angle that is decreasing and drops below a first navigation threshold, for example a roll angle of 3 degrees, the path estimator 20, or the controller 22, deduces from this that the drone 1 is now flying in a straight line.

Starting from a situation in which the drone 1 is flying in a straight line, if the absolute value of the item of navigation data DNAV is a roll angle that is increasing and passes above a second navigation threshold, the second navigation threshold being greater than the first navigation threshold and, for example, 5 degrees, the path estimator 20, or the controller 22, estimates that the drone 1 is now performing a turn.

In reference to FIG. 3, if the drone 1 is flying in a straight line, the path estimator 20, or the controller 22, may be configured so that the path symbol 50 is a segment 51 extending from the aircraft symbol 35, for example from a vertex of the aircraft symbol and/or at the current heading or track angle. The path estimator 20, or the controller 22, may calculate the length 62 of the segment 51 in order to illustrate the predicted path that the drone 1 will follow for a predetermined upcoming time period. The length is then equal to the product of the scale factor, the speed in meters per second and the time period in seconds. The pilot of the drone 1 may then assess whether he or she needs to apply corrective actions in order for the drone 1 to remain within the authorized airspace 100.

As previously indicated, the predetermined time period may be stored or set. The length 62 may possibly be limited by a predetermined maximum length in order to never exceed a predetermined maximum length.

In reference to FIG. 2, if the drone 1 is considered to be performing a turn, the path estimator 20, or the controller 22, may be configured to determine, before the step of displaying STP5 several symbols, a turn radius R based on at least the item of speed data DVIT and the item of navigation data DNAV, or based only on the item of speed data DVIT and the item of navigation data DNAV. The path estimator 20, or the controller 22, is configured to determine, during the step of displaying STP5 several symbols, said geometry of the path symbol 50, also based on this turn radius R.

For example, the turn radius is determined using the following relation:

R=(V*V)/(g*tan(phi))

where “R” represents the turn radius, “V” represents the item of speed data (DVIT), “g” represents the acceleration of gravity, “phi” represents the item of navigation data (DNAV) in the form of a roll angle, “=” represents the equals sign, “/” represents the division sign and “*” represents the multiplication sign.

Alternatively, and depending on the nature of the item of navigation data, the turn radius is determined using the following relation:

R=V/(dxi/dt)

where “R” represents the turn radius, “V” represents the item of speed data DVIT, “dxi/dt” represents the derivative or the pseudo-derivative over time of the item of navigation data DNAV in the form of a track or heading angle, “=” represents the equals sign and “/” represents the division sign.

The path estimator 20, or the controller 22, may have the ability to apply the two relations indicated above, the path estimator 20, or the controller 22, selecting the required alternative depending on the item of navigation data received or a setting made with an interface of the path estimator 20 or the like.

In reference to FIG. 4, the path estimator 20, or the controller 22, may be configured to give the path symbol 50 the shape of an arc 56 with the turn radius R multiplied by a scale factor.

According to another example, the aircraft symbol 35 is positioned along a first geometric axis AX1 dividing a screen 210 of the display 21 into a first side 26 and a second side 27.

The path estimator 20, or the controller 22, is then configured to determine on which side 26, 27 the path symbol 50 should be positioned, by comparing the item of navigation data DNAV with at least one navigation threshold. For example, if the roll angle is negative, the path symbol 50 should be positioned on the second side 27 and if the roll angle is positive, the path symbol 50 should be positioned on the first side 26, as shown in FIG. 4, the navigation threshold being equal to zero in this case. A similar test may be carried out based on the track or heading angle.

The path estimator 20, or the controller 22, is then configured to determine the position of a center 57. This center 57 should be situated along a second axis AX2 orthogonal to the first axis AX1, on the appropriate side 26, 27, and at a distance 61 from the aircraft symbol 35, or from the intersection between the first axis and the second axis. The distance 61 is equal to the product of the turn radius R and the scale factor. The axis AX2 may be positioned in relation to a reference point of the aircraft symbol 35.

By applying conventional trigonometric formulae, the path estimator 20, or the controller 22, is configured to draw an arc 56 centered on the center 57 and starting from said aircraft symbol 35.

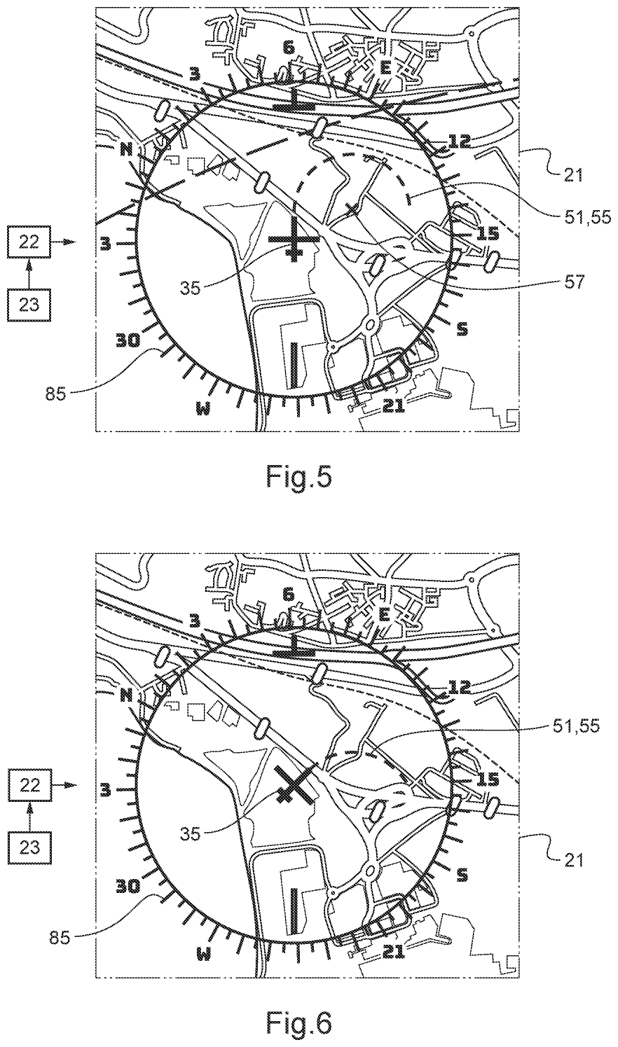

The arc 56 may extend over a length 62 in order to show the predicted path that the drone 1 will follow for a predetermined upcoming time period. As previously indicated, the predetermined time period may be stored or set. The length 62 may optionally be limited to a predetermined maximum length. According to the example in FIG. 5, the length may be limited so that the arc 56 at most describes a semi-circle.

According to another variant, the path estimator 20, or the controller 22, may take into consideration the wind in order to deform the path symbol 50, according to known methods.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

For example, FIG. 3 shows the various steps of the method described above in a particular order. However, a different order can be used. For example, the disabling step STPT may be carried out at any time before the step of displaying SIPS several symbols.

What is claimed is:

1. A method for helping to keep a drone within an authorized airspace,
wherein the method comprises the following steps:
determining, with a path estimator not embedded on the drone, a value of an item of speed data of the drone and a value of an item of location data carrying a current position of the drone and a value of an item of navigation data of the drone making it possible to assess whether the drone is flying in a straight line or performing a turn; and
displaying several symbols on a display of the path estimator, the displaying of several symbols comprising: i) displaying an aircraft symbol showing a current position of the drone; ii) displaying a boundary symbol showing a boundary of the authorized airspace in a position in relation to the aircraft symbol representative of a position of the boundary of the authorized airspace in relation to the current position of the drone; and iii) determining a geometry and displaying a path symbol showing a predicted path of the drone without changing values of the item of speed data and the item of navigation data, the geometry of the path symbol being a shape of the path symbol determined using a stored model based at least on the value of the item of speed data and the value of the item of navigation data.

2. The method according to claim 1,
wherein the path symbol is positioned in relation to a current heading angle or a current track angle of the drone.

3. The method according to claim 1,
wherein the item of speed data is an air speed or a ground speed, and the item of navigation data is a roll angle or a heading angle or a track angle.

4. The method according to claim 1,
wherein, before displaying several symbols, the method comprises determining whether the drone is flying in a straight line or performing a turn based on the item of navigation data with or without hysteresis, the path symbol being in the form of a segment during a flight in a straight line and a curve during a turn.

5. The method according to claim 4,
wherein, before displaying several symbols and when a turn is being performed, the method comprises determining with the path estimator a turn radius (R) based on the item of speed data and the item of navigation data, the geometry of the path symbol being based on the turn radius.

6. The method according to claim 5,
wherein the path symbol is in the shape of an arc with the turn radius multiplied by a scale factor.

7. The method according to claim 5,
wherein the turn radius is determined using the following relation:
R=(V*V)/(g*tan(phi))
where “R” represents the turn radius, “V” represents the item of speed data, “g” represents the acceleration of gravity, “phi” represents the item of navigation data in the form of a roll angle, “=” represents the equals sign, “/” represents the division sign and “*” represents the multiplication sign.

8. The method according to claim 5,
wherein the turn radius is determined using the following relation:
R=V/(dxi/dt)
where “R” represents the turn radius, “V” represents the item of speed data, “dxi/dt” represents the derivative or the pseudo-derivative of the item of navigation data in the form of a track or heading angle, “=” represents the equals sign and “/” represents the division sign.

9. The method according to claim 5,
wherein the aircraft symbol is positioned along a first geometric axis dividing a screen of the display into a first side and a second side, during a turn, the method comprises determining the position of a center along a second axis orthogonal to the first axis at a distance from the aircraft symbol equal to the product of the turn radius and a scale factor, the method comprising comparing the value of the item of navigation data with at least one navigation threshold, the center being positioned on the first side or the second side depending on the comparison, the path symbol having an arc starting from the aircraft symbol and centered on the center.

10. The method according to claim 1,
wherein the path symbol carries the predicted path that the drone will follow for a fixed or adjustable upcoming time period, a length of the path symbol being limited in order not to exceed a predetermined length.

11. The method according to claim 1,
wherein displaying of the path symbol is disabled below a stored air speed or ground speed of the drone, with or without hysteresis.

12. The method according to claim 1,
wherein the method comprises filtering at least one item of data from the item of speed data and the item of navigation data with a low-pass filter.

13. The method according to claim 1,
wherein displaying of several symbols comprises displaying, on the display), a representation of the overflown terrain on top of which the aircraft symbol, the boundary symbol and the path symbol are superposed.

14. A non-embedded path estimator for a drone,
wherein the path estimator is configured to implement the method according to claim 1.

15. A kit comprising a drone and the path estimator not embedded on the drone,
wherein the path estimator is according to claim 14.

16. The kit according to claim 15,
wherein the drone comprises a speed sensor measuring the item of speed data and a navigation sensor) measuring the item of navigation data and a position sensor measuring the item of location data, the drone having a transmitter transmitting the item of speed data and the item of navigation data and the item of location data, the path estimator having a receiver receiving the item of speed data and the item of navigation data and the item of location data.
